(19) United States
(12) Patent Application Publication
(10) Pub. No.: US 2011/0215778 A1
(43) Pub. Date: Sep. 8, 2011

(54) SOLAR POWER CONVERTER WITH MULTIPLE OUTPUTS AND CONVERSION CIRCUIT THEREOF

(75) Inventor: YU-KAI CHEN, CHIAYI CITY 600 (TW)

(73) Assignee: NATIONAL FORMOSA UNIVERSITY, YUNLIN COUNTY 632 (TW)

(21) Appl. No.: 12/952,576

(22) Filed: Nov. 23, 2010

(30) Foreign Application Priority Data
Mar. 3, 2010 (TW) 99106122

(51) Int. Cl. H02M 3/335

(52) U.S. Cl. 323/267

(57) ABSTRACT

A solar power converter with multiple outputs and conversion circuit thereof is disclosed. One embodiment of the solar power converter includes a power input terminal, a solar power unit and a solar power conversion circuit with multiple outputs including a primary circuit, a first output circuit, a second output circuit, and a transformer with a first auxiliary winding, a second auxiliary winding and a primary winding. An output terminal of the second output circuit is connected to the power input terminal in series for providing a third output voltage to a load unit. The third output voltage is a sum of an input voltage generated by the solar power unit and a second output voltage generated by the second output circuit.

### BACKGROUND OF THE INVENTION

1. Field of the Invention

The present invention relates to a power conversion circuit; in particular, to a power conversion circuit having an isolated solar power converter connected in series for facilitating multiple outputs.

2. Description of Related Art

Photovoltaic technology applications include the development of solar cell battery efficiency and overall power conversion efficiency of the solar power converter. Because the operating point of the solar cell battery shifts when the surrounding temperature and illumination vary, a maximum power point tracking has been introduced to ensure an output of a maximum power by controlling the operating point. A conventional maximum power point tracking, for example, includes perturbing an output voltage of the solar cell battery, detecting an output power of a converter, comparing the detected output power in different times, and then determining a perturbation direction of the output voltage for the solar cell.

However, for maximizing the output power the conventional power conversion generally utilizes a complex circuit so as to obtain the information of the operating point associated with the output of the maximum power, at the expense of the corresponding manufacturing cost.

Referring to FIG. 1, in which a block diagram of a conventional solar power converter with multiple outputs is demonstrated. The solar power converter 1 includes a solar power module 10, a boost DC/DC converter 12, a high voltage load 14, a buck DC/DC converter 16, and a low voltage load 18. The boost DC/DC converter 12 boosts up a voltage of the solar power module 10, so that a current Iₒ is applicable to the high voltage load 14. The buck DC/DC converter 16 converts and transforms the power passing through the buck DC/DC converter 16 to be associated with a reduced voltage so that the reduced voltage is applicable to the low voltage load 18. When the multiple outputs become necessary, the number and the complexity of the converters have to increase in response, complicating the entire circuitry with much higher manufacturing cost.

### SUMMARY OF THE INVENTION

The present invention provides a solar power converter with multiple outputs and a conversion circuit thereof. The solar power converter according to the present invention when compared with its conventional counterparts is more simplified in the circuit design, so that a number of overall components decreases, thereby achieving the objectives of optimizing the power conversion efficiency and decreasing the overall manufacturing cost.

To achieve the aforementioned objectives, a solar power converter according to one embodiment of the present invention includes a solar power unit, a power input terminal for receiving an input voltage converted from a solar power, and a solar power conversion circuit with multiple outputs. The solar power conversion circuit further includes a primary circuit, a first output circuit, a second output circuit, and a transformer. The transformer comprises a first auxiliary winding, a second auxiliary winding, and a primary winding. An output terminal of the second output circuit is connected to the power input terminal in series for providing a third output voltage to a load unit. The third output voltage is a sum of an input voltage generated by the solar power unit and a second output voltage generated by the second output circuit.

Therefore, because the circuit design of the solar power converter with multiple outputs and the conversion circuit thereof is modified and the connection relationship among necessary electronic components has been altered, the solar power converter according to the present invention may associate with a simplified circuit design and a reduced manufacturing cost while incorporating the maximum solar power track capability. Also, as the operating point that corresponds to the output of the maximum power tends not to differ drastically in nature the simplified solar power converter based on the present invention could still be capable of providing multiple outputs with superior power conversion efficiency.

In order to further the understanding regarding the present invention, the following embodiments are provided along with illustrations to facilitate the disclosure of the present invention.

### BRIEF DESCRIPTION OF THE DRAWINGS

FIG. 1 illustrates a block diagram of a conventional solar power converter with multiple outputs;

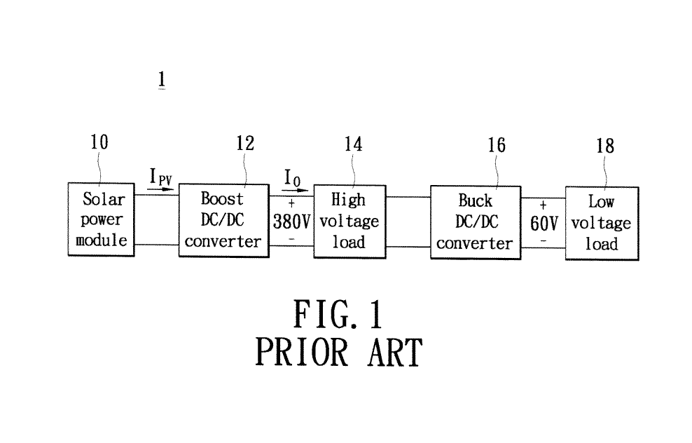

FIG. 2 illustrates a voltage-power characteristic curve of a maximum solar power point under different illuminations;

FIG. 3 illustrates a voltage-power characteristic curve of a maximum solar power point under different temperatures;

FIG. 4 illustrates a block diagram of a solar power converter according to the present invention;

FIG. 5 illustrates a circuit diagram of an embodiment of the solar power converter according to the present invention;

FIG. 6 illustrates a circuit diagram of another embodiment of the solar power converter according to the present invention; and

FIG. 7 illustrates a circuit diagram of yet another embodiment of the solar power converter according to the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

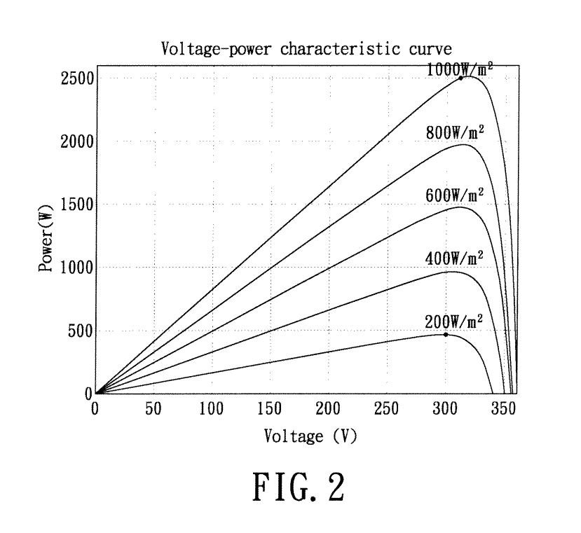

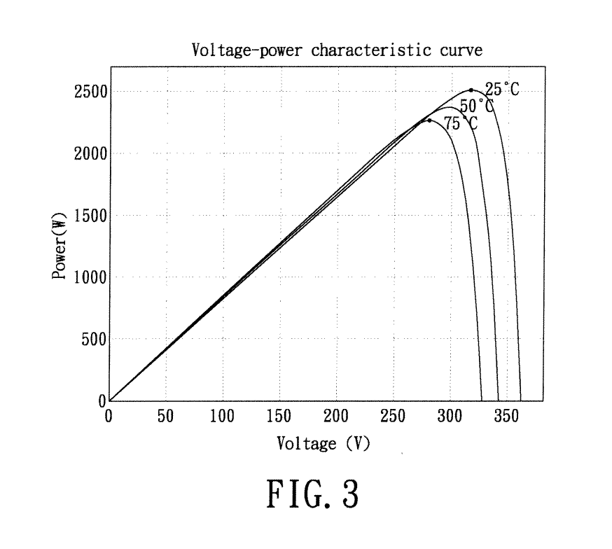

Please refer to FIG. 2, in which a voltage-power characteristic curve of a maximum solar power point under different illuminations is demonstrated. As shown in FIG. 2, when an illumination is at 1,000 W/m², a voltage associated with the maximum solar power point is 318.4 V, and when the illumination is at 800 W/m² the voltage corresponding to the maximum solar power point stands at 313.2 V. Additionally, as the illumination is at 600 W/m² the voltage associated with the maximum solar power point is 311.7 V with the voltage of the maximum solar power point at 306.3 V as the illumination is at 400 W/m². Meanwhile, as the illumination is at 200 W/m² the voltage of the maximum solar power point is 297.1 V. Please refer to FIG. 3, in which a voltage-power characteristic curve of the maximum solar power point under different temperatures is demonstrated. As shown is FIG. 3, when the temperature is at 25 degrees the voltage of a maximum solar power point is 318.4 V and as the temperature is at 50 degrees the voltage of the maximum solar power point is 297.5 V. Plus, as the temperature is at 75 degrees the voltage of the maximum solar power point is 280.9 V. To sum up, when the illumination varies from 200 W/m² to 1,000 W/m² the voltage variation ΔV for the maximum solar power point is 21.3 V. While the temperature varies from 25 degrees to 75 degrees, the voltage variation ΔV for the maximum solar power point is 37.5 V. Even though the output of the power is primarily affected by the environmental conditions, such as the temperature and the illumination, the voltage variation for the maximum solar power point under different temperatures and illuminations does not drastically vary.

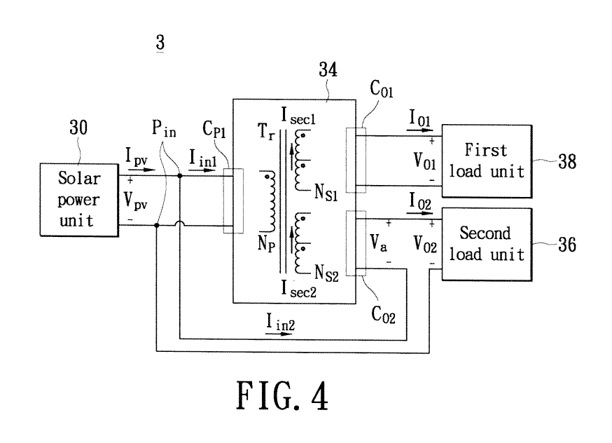

Please refer to FIG. 4, in which a block diagram of a solar power converter according to the present invention is demonstrated. The solar power converter 3 comprises a solar power unit 30, a solar power conversion circuit with multiple outputs 34, a second load unit 36, and a first load unit 38. The solar power unit 30, which is composed of a plurality of photovoltaic arrays connected in series or in parallel, provides a solar energy and an input voltage. The solar power conversion circuit with multiple outputs 34 couples to first load units 38 and second load unit 36.

The converter of the embodiment presented incorporates the maximum power point tracking technology, e.g., a perturbation and observation method, and a voltage and current regulations at the outputting terminal for improving the overall system conversion efficiency. The first load unit 38 may be a low voltage unit and the second load unit 36 may be a high load unit. The solar power conversion circuit with multiple outputs 34 of the solar power converter 3 is connected with the solar power unit 30 via a power input terminal Pᵢₙ. The solar power conversion circuit with multiple outputs 34 further includes a primary circuit Cₚ₁, a first output circuit Cₒ₁, a second output circuit Cₒ₂, and a transformer Tᵣ. The transformer Tᵣ₂ includes a first auxiliary winding Nₛ₁, a second auxiliary winding Nₛ₂, and a primary winding Nₚ.

The primary circuit Cₚ₁, coupled between the power input terminal Pᵢₙ and the primary winding Nₚ, provides a switch signal to the primary winding Nₚ in response to the input voltage. The first output circuit Cₒ₁, coupled to the first auxiliary winding Nₛ₁, outputs a first output voltage Vₒ₁ in response to the switching signal and supplies the first output voltage Vₒ₁ to the first load unit 38. The second output circuit Cₒ₂, coupled to the second auxiliary winding Nₛ₂, outputs a second output voltage Vₐ in response to the switching signal. The power input terminal Pᵢₙ is connected in series with an output terminal of the second output circuit Cₒ₂ for providing a third output voltage Vₒ₁ with the second load 36. The third output voltage Vₒ₂ is a sum of the input voltage, i.e., a photovoltaic voltage Vₚᵥ, and the second output voltage Vₐ.

The first auxiliary winding Nₛ₁ of the solar power conversion circuit with multiple outputs 34 is mutually inducted to generate a secondary current I_{sec1} by a current passing through the primary winding Nₚ. A first output current Iₒ₁ passing through the first output circuit Cₒ₁ is the secondary current I_{sec1}. Meanwhile, the second auxiliary winding Nₛ₂ of the solar power conversion circuit with multiple outputs 34 is mutually inducted to generate another secondary current I_{sec2} by the current passing through the primary winding Nₚ. The second output circuit Iₒ₂ passes through the second output circuit Cₒ₂. The power input terminal Pᵢₙ couples to a terminal of the second auxiliary winding Nₛ₂ and the output terminal. Accordingly, a photovoltaic current Iₚᵥ may pass through the primary winding Nₚ and the second auxiliary winding Nₛ₂. The current component that passes through the second auxiliary winding Nₛ₂ is a second input current Iᵢₙ₂ with another current component passing through the primary winding Nₚ as a first input current Iᵢₙ₁. The second input current Iᵢₙ₂ may merge with the secondary current I_{sec2}, which is mutually inductively generated from the second auxiliary winding Nₛ₂, so that the second output current Iₒ₂ may be present at the second output circuit Cₒ₂.

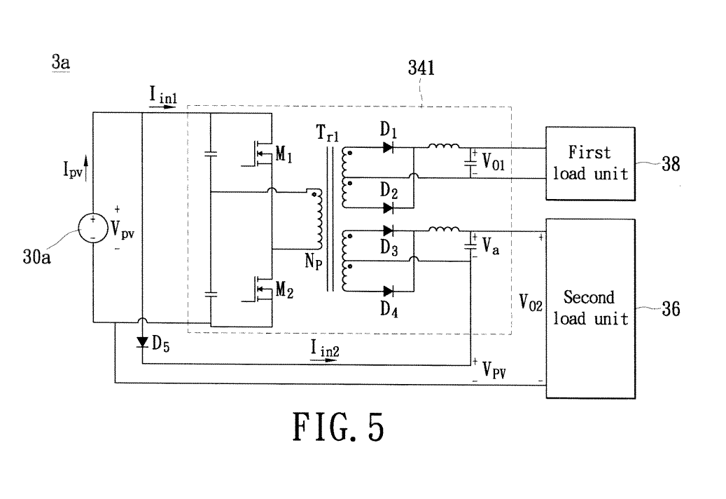

Next, please refer to FIG. 5, in conjunction with FIG. 4, in which a circuit diagram of an embodiment of the solar power converter according to the present invention is demonstrated. A solar power conversion circuit with multiple outputs in the solar power converter 3a is a half-bridge conversion circuit 341. The first output circuit Cₒ₁ has diodes D₁, and D₂, the second output circuit Cₒ₂ has diodes D₃ and D₄, and the primary winding Nₚ is turned on/off by switch components M₁ and M₂. In the embodiment shown in FIG. 5, all other circuit connection configuration is similar to that of FIG. 4. The embodiment is demonstrated for example, but not limited thereto. Further, since the technical principles of the half-bridge conversion circuit 341 are well known for those people skilled in the art, the details of the half-bridge conversion circuit 341 will not be described herein.

Because the circuitry configuration in series connection of the embodiment, the third output voltage Vₒ₂ of the second load unit 36 is a sum of the photovoltaic voltage Vₚᵥ plus the second output voltage Vₐ. The unilaterally conductive component D₅, coupled between the power input terminal Pᵢₙ and the outputting terminal of the second output circuit Cₒ₂, controls the current between the power input terminal Pᵢₙ and the second output circuit Cₒ₂ (i.e., the second input current Iᵢₙ₂) flowing from the power input terminal Pᵢₙ to the second output circuit Cₒ₂. The photovoltaic current Iₚᵥ generated from the solar power unit 30a may include a first input current Iᵢₙ₁ and a second input current Iᵢₙ₂ with only the first input current Iᵢₙ₁ passing through the transformer Tᵣ₁ of the half-bridge conversion circuit 341. Consequently, the converter of the embodiment only needs to process a part of the input current, for example, the first input current Iᵢₙ₁, and thus a reduced power is processed by the half-bridge conversion circuit 341. Therefore, the simplified circuitry may be sufficient to implement the current embodiment with reduced manufacturing cost.

For example, as the photovoltaic voltage Vₚᵥ generated from the solar power unit ranges from 280.9 V to 318.4 V, the overall solar output power is 5 kW, the first output voltage Vₒ₁ is 60 V (the first load unit 38 is a low voltage load unit), and the third output voltage Vₒ₂ is 380 V (the second load unit 36 is a high voltage load unit). Because the half-bridge conversion circuit 341 only needs to process 100 V (380V−280.9 V), the power required for the half-bridge conversion circuit 341 is about 1,454 W, which is about 29% of what the conventional conversion circuit processes ((1,454/5,000)×100%). Moreover, since the overall solar output power is 5 kW, the conventional loss power for conversion is about 250 W (5 kW×95%) assume 95% is the circuit conversion efficiency of the conventional conversion circuit. With the power loss of the embodiment according to the present invention standing at about 218 W, which is less than the power loss associated with the conventional converter, the overall circuit conversion efficiency of the solar power converter 3a in accordance with the present invention improves.

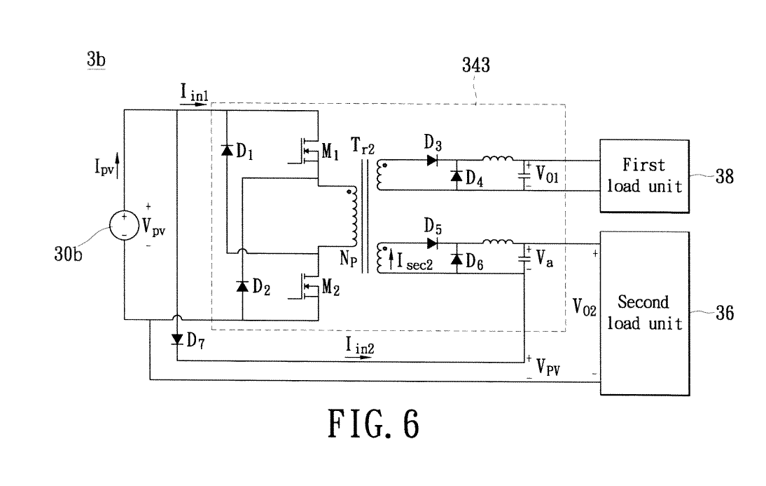

Please refer to FIG. 6, in conjunction with FIG. 4, in which a circuit diagram of another embodiment of the solar power converter according to the present invention is demonstrated. In the current embodiment, the circuitry connection configuration of the solar power converter 3b is a similar to that of the embodiment shown in FIG. 4, other than the solar power conversion circuit with multiple outputs is implemented in the form of a two-switch forward converter 343. The primary circuit Cₚ₁ has diodes D₁ and D₂ and switching components M₁ and M₂. The first output circuit Cₒ₁ has diodes D₃ and D₄. The second output circuit Cₒ₂ has diodes D₅ and D₆. The third output voltage Vₒ₂ of the second load unit 36 is a sum of the photovoltaic voltage Vₚᵥ plus the second output voltage Vₐ. The photovoltaic current Iₚ, generated from the solar power unit 30b may include a first input current Iᵢₙ₁ and a second input current Iᵢₙ₂. And the first input current Iᵢₙ₁ passes through the transformer Tᵣ₂ of the two-switch forward converter 343. A uni-polar conductive component D₇ controls the second input current Iᵢₙ₂ to flow from the power input terminal Pᵢₙ to the second output circuit Cₒ₂. The second input current Iᵢₙ₂ and the secondary current I_{sec2} is merged into a second output current Iₒ₂.

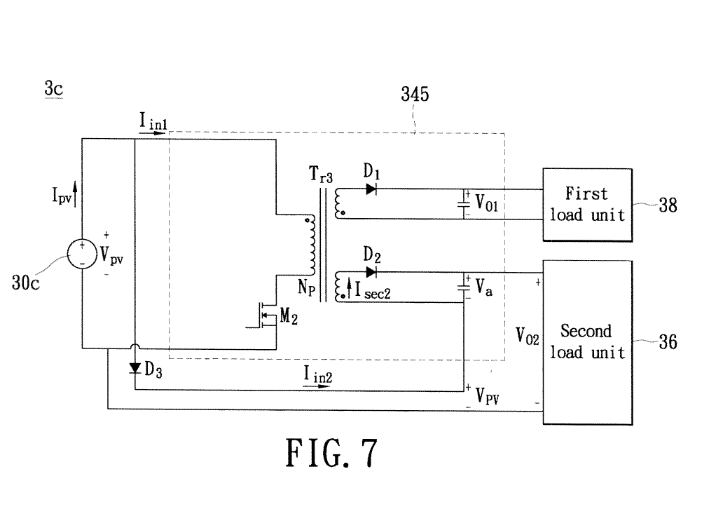

Similarly, please refer to FIG. 7, in conjunction with FIG. 4, in which a circuit diagram of yet another embodiment of the solar power converter according to the present invention is demonstrated. In the embodiment, the solar power converter 3c has a similar circuitry connection configuration as that of FIG. 4, other than implementing the solar power conversion circuit with multiple outputs by a fly-back converter 345. The primary circuit Cₚ₁ has a switching component M₂. The first output circuit Cₒ₁ has a diode D₁. The second output circuit Cₒ₂ has a diode D₂. The third output voltage Vₒ₂ of the second load unit 36 is a sum of the photovoltaic voltage Vₚᵥ plus the second output voltage Vₐ. The photovoltaic current Iₚᵥ generated from the solar power unit 30c may include a first input current Iᵢₙ₁ and a second input current Iᵢₙ₂. The first input current Iᵢₙ₁ passes through the transformer Tᵣ₃ of the fly-back converter 345. A uni-polar conductive component D₃ controls the second input current Iᵢₙ₂ to flow from the power input terminal Pᵢₙ to the second output circuit Cₒ₂. The second input current Iᵢₙ₂ and the secondary current I_{sec2} is merged into a second output current Iₒ₂. The transformer Tᵣ₃ includes first auxiliary windings and second auxiliary windings, both of which are respectively coupled to first load units and second load units. It is worth noting that the embodiment is illustrated for example, but is not limited thereto.

The solar power converter according to the present invention is simplified in design with reduced manufacturing cost and improved conversion efficiency when altering the connection relationship among electronic components of the power converter and utilizing the characteristics including the solar power output is affected by environmental conditions of the power converter, e.g., a temperature and an illumination, and the relatively slight voltage variation associated with the maximum solar power output. Meanwhile, as the power to be processed by the power converter according to the present invention has been reduced, the circuit configuration could be simplified to achieve the goal of reducing the corresponding manufacturing cost. The power converter according to the present invention may be further applicable to both of a high voltage load and a low voltage load.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A solar power conversion circuit with multiple outputs, comprising:
a power input terminal, for receiving an input voltage;
a transformer, including a primary winding, a first auxiliary winding, and a second auxiliary winding;
a primary circuit, coupled between the primary winding and the power input terminal, for providing a switching signal to the primary circuit in response to the input voltage;
a first output circuit, coupled to the first auxiliary winding, for outputting a first output voltage to a first load unit in response to the switching signal; and
a second output circuit, coupled to the second auxiliary winding, for outputting a second output voltage in response to the switching signal;
wherein the power input terminal is connected with an output terminal of the second output circuit so as to provide a third output voltage to a second load unit, and the third output voltage is a sum of the input voltage and the second output voltage.

2. The solar power conversion circuit with multiple outputs according to claim 1, further comprising:
a uni-polar conductive component, coupled between the power input terminal and the output terminal of the second output circuit, for controlling a current passing from the power input terminal to the second output circuit.

3. The solar power conversion circuit with multiple outputs according to claim 1, wherein the transformer, the primary circuit, the first output circuit, and the second output circuit are configured into a half-bridge conversion circuit, a two-switch forward converter, or a fly-back converter.

4. The solar power conversion circuit with multiple outputs according to claim 1, wherein the solar power conversion circuit performs a power conversion by incorporating a maximum power point tracking and a voltage and a current regulation at the output terminal.

5. A solar power converter with multiple outputs, comprising:
a solar power unit, for converting a solar power into an input voltage;
a power input terminal, for receiving the input voltage;
a transformer, including a primary winding, a first auxiliary winding, and a second auxiliary winding;
a primary circuit, coupled between the primary winding and the power input terminal, for providing a switching signal to the primary circuit in response to the input voltage;
a first output circuit, coupled to the first auxiliary winding, for outputting a first output voltage to a first load unit in response to the switching signal; and
a second output circuit, coupled to the second auxiliary winding, for outputting a second output voltage in response to the switching signal;
wherein the power input terminal is connected with an output terminal of the second output circuit so as to provide a third output voltage to a second load unit, and the third output voltage is a sum of the input voltage and the second output voltage.

6. The solar power converter with multiple outputs according to claim 5, wherein the solar power unit is composed of a plurality of photovoltaic arrays.

7. The solar power converter with multiple outputs according to claim 5, wherein the transformer, the primary circuit, the first output circuit, and the second output circuit are configured into a half-bridge conversion circuit, a two-switch forward converter, or a fly-back converter.

8. The solar power converter with multiple outputs according to claim 5, further comprising:
a unilaterally conductive component, coupled between the power input terminal and the output terminal of the second output circuit, for controlling a current passing from the power input terminal to the second output circuit.

9. The solar power converter with multiple outputs according to claim 8, wherein the solar power unit provides a photovoltaic current passing through the power input terminal, wherein the photovoltaic current includes a first input current passing through the primary circuit and a second input current passing through the second output circuit.

10. The solar power converter with multiple outputs according to claim 5, wherein the first load unit is a low voltage load with respect to the second load unit.
